(19) United States
(12) Patent Application Publication
(10) Pub. No.: US 2014/0266943 A1
(43) Pub. Date: Sep. 18, 2014

(54) ANTENNA ALIGNMENT ADJUSTMENT MECHANISM

(71) Applicant: ANDREW LLC, Hickory, NC (US)

(72) Inventors: Alexander Peter Thomson, Livingston (GB); Christopher D. Hills, Glenrothes (GB); Claudio Biancotto, Edinburgh (GB)

(73) Assignee: ANDREW LLC, Hickory, NC (US)

(21) Appl. No.: 13/800,429

(22) Filed: Mar. 13, 2013

(51) Int. Cl. H01Q 3/08

(52) U.S. Cl. CPC H01Q 3/08
USPC 343/765; 343/880; 29/893.1

(57) ABSTRACT

A polarization adjustment assembly for a reflector antenna is provided with a radio bracket with a mounting flange. The mounting flange is coupled to a hub provided with a stop portion. Fasteners couple the radio bracket to the hub via slots in the mounting flange, rotatable with respect to the hub within the extents of the slots. An adjustment bolt passes through a boss coupled to the mounting flange. The adjustment bolt abuts the stop portion, whereby longitudinal displacement of the adjustment bolt with respect to the boss rotates the radio bracket with respect to the hub. Alternatively, the positions of the boss and stop portion on the mounting flange and hub may be exchanged.

### BACKGROUND

1. Field of the Invention

This invention relates to antennas. More particularly, the invention relates to an antenna alignment adjustment assembly that enables fine adjustment in a simplified and compact structure.

2. Description of Related Art

Antennas may be highly directional. In addition to being closely boresight-aligned with one another, antennas and feed components contained therein forming an RF communications link may be rotationally aligned with respect to signal polarity.

Alignment mechanisms may be incorporated into the mounting arrangement of the antenna. Antenna mounts relying upon arc slots for controlled angular movement about a center axis of the arc slot are known. Fine adjustment of an arc slot-type antenna mount may be problematic as the fasteners associated with locking the mount at the desired position along the arc slot may have a significant amount of slop when loosened enough to enable movement, frustrating tightening the mount at the desired orientation and/or fine adjustment of the orientation. Application of finely threaded rod and boss arrangements to drive the mount along the arc slot, including a bias member to remove any slop are also known, for example as disclosed in U.S. Pat. No. 7,046,210 “Precision Adjustment Antenna Mount and Alignment Method” issued ion 16 May 2006 to Brooker et al. However, the multiple additional elements and clearance therebetween required for this type of arrangement may increase the size of the mount and/or overly complicate manufacture of the mount.

Antenna mounts utilizing gears are also known. However, gears and structure required for maintaining the gears in aligned engagement with each other may similarly increase the size, complexity and cost of the of the mount.

Antennas may be installed at exposed locations high atop towers. Improved installation and/or maintenance personnel safety is a constant concern of the radio tower industry. Therefore, installation and/or adjustment procedures with a reduced number of steps and low installer force requirements are desired. Further, antenna specific tools are not desired as each additional tool presents an additional cost, separate drop hazard and ongoing inventory requirement.

Competition in the reflector antenna market has focused attention on improving electrical performance and minimizing overall manufacturing, inventory, distribution, installation and maintenance costs. Therefore, it is an object of the invention to provide an antenna alignment mechanism with a fine adjustment capability that overcomes deficiencies in the prior art.

### BRIEF DESCRIPTION OF THE DRAWINGS

The accompanying drawings, which are incorporated in and constitute a part of this specification, illustrate embodiments of the invention, where like reference numbers in the drawing figures refer to the same feature or element and may not be described in detail for every drawing figure in which they appear and, together with a general description of the invention given above, and the detailed description of the embodiments given below, serve to explain the principles of the invention.

FIG. 1 is a schematic isometric exploded view of a first exemplary embodiment of an alignment mechanism.

FIG. 2 is a schematic back view of the alignment mechanism of FIG. 1, pinion gear removed for clarity.

FIG. 3 is a schematic side view of the alignment mechanism of FIG. 1

FIG. 4 is a schematic isometric exploded view of a second exemplary embodiment of an alignment mechanism.

FIG. 5 is a schematic back view of the alignment mechanism of FIG. 4, pinion gear removed for clarity.

FIG. 6 is a schematic side view of the alignment mechanism of FIG. 4

FIG. 7 is a front view of an exemplary antenna mount utilizing 3 alignment mechanisms for polarization, elevation and azimuth alignment of an antenna mounted to a pole, demonstrating a first range of polarization adjustment.

FIG. 8 is a front view of the antenna mount of FIG. 7, demonstrating a second range of polarization adjustment.

FIG. 9 is a top view of the antenna mount of FIG. 7, demonstrating a first range of azimuth adjustment.

FIG. 10 is a top view of the antenna mount of FIG. 7, demonstrating a second range of azimuth adjustment.

FIG. 11 is a side view of the antenna mount of FIG. 7, demonstrating a first range of elevation adjustment.

FIG. 12 is a side view of the antenna mount of FIG. 7, demonstrating a second range of elevation adjustment.

FIG. 13 is schematic isometric view of an exemplary antenna mount utilizing 3 alignment mechanisms for polarization, elevation and azimuth alignment of an antenna mounted to a pole, demonstrating application of motors to drive the elevation and azimuth adjustment.

### DETAILED DESCRIPTION

The inventors have recognized that precision adjustment may be applied to an antenna alignment adjustment mechanism by forming an annular gear integral with one of two bodies rotatably coupled to one another and driving the annular gear with a pinion gear coupled to the other body. Thereby, the mechanism requirements may be simplified, a gear ratio between the annular gear and the pinion gear enabling precision adjustment by rotation of the pinion gear. The arrangement may be applied with respect to multiple axis of adjustment, enabling a compact mechanism adjustable in azimuth, elevation and/or polarization (boresight rotation).

A first exemplary embodiment of an alignment mechanism 2, as demonstrated in FIGS. 1-3, has a first body 4 with a circular arc surface 6. The circular arc surface 6 is provided as an arc slot 8 centered upon a center point 10. An inner sidewall 11 of the arc slot 8 has an annular gear 12 formed therein. A pinion gear 14 is rotatably coupled to the second body 16 by a spindle 18. The pinion gear 14 and second body 16 retain the first body 4 therebetween, the pinion gear 14 engaged with the annular gear 12. A second spindle 18 passes through another arc slot 8 of the first body 4, also provided as a circular arc centered upon the center point 10, providing a second point of rotation guide and retention between the first and second bodies 4, 16. As the pinion gear 14 is rotated, the annular gear 12 is driven, rotating the first body 4 with respect to the second body 16, about the center point 10.

Alternatively, for example as shown in FIGS. 4-6, the rotatable coupling between the first and second bodies 4, 16 may be around a spindle 18 applied to the center point 10, eliminating the need for the additional arc slot 8.

As best shown in FIGS. 1 and 4, the pinion gear 14 may be provided with a tool interface 20, such as a wrench face or hex key aperture for a common hand tool to rotate the pinion gear 14. Washers 22 may be applied for ease of tightening of the spindles 18, by threading into the second body 16 or alternatively into a nut or the like on an opposite side of the second body 16 to lock the pinion gear 14 and retain the first body 4 locked against the second body 16 when the desired orientation has been reached.

As shown in FIGS. 7-12, multiple alignment mechanisms 2 may be applied to form an antenna mount 24 that couples the antenna 26 to a desired mounting point such as a pole 28, wherein the first body 4 is coupled to the antenna and the second body 16 is coupled to the pole 28 (or vice versa).

One of the alignment mechanisms 2 may be applied to rotate the antenna along a rotation axis between the first body 4 and the second body 16 that is coaxial with a boresight of the antenna 26, for example as shown in FIGS. 7 and 8, to allow polarization adjustment of the antenna 26.

One of the alignment mechanisms 2 may be applied to rotate the antenna along a rotation axis between the first body and the second body that is parallel to a vertical plane of the antenna 26, for example as shown in FIGS. 9 and 10, to allow azimuth adjustment of the antenna 26.

One of the alignment mechanisms 2 may be applied to rotate the antenna along a rotation axis between the first body and the second body that is parallel to a horizontal plane of the antenna 26, for example as shown in FIGS. 11 and 12, to allow elevation adjustment of the antenna 26.

To improve load distribution upon the alignment mechanisms 2, the first and second bodies 4, 16 may be applied as U-shaped brackets meshing between dual flange ends 34, an axis of rotation passing through the center of rotation 10 of an alignment mechanism 2 at one flange end 32 and through a corresponding arc slot 8 (first body 4) and rotation fastener 34 (coupled to second body 16) at the other flange end 32. Alternatively, dual flange ends 32 may be applied spaced apart from one another, for example as shown in FIG. 13, utilizing the antenna 26 as structure for retaining the spacing and alignment therebetween.

One skilled in the art will appreciate that the pinion gears 14 may alternatively be configured for rotation by coupling the pinion gears 14 to the shafts of motors which are mounted upon the respective second bodies 16, for example as shown in FIG. 13.

The generally planar surfaces between the contacting portions of the first body 4 and the second body 16 may simplify manufacture. For example, the first and second bodies may be cost efficiently manufactured via injection molding, casting, metal stamping or the like.

The first body 4 and annular gear 12 have been demonstrated as a unitary portion. One skilled in the art will appreciate that “unitary”, as applied herein, is defined as describing the first body 4 and annular gear 12 as a single contiguous portion of homogeneous material. Therefore, a first body 4 and annular gear 12 thereof would not be the result of integrating separate sub-elements by welding, soldering, gluing or the like. In alternative embodiments, the annular gear 12 may be separately manufactured and then seated, for example, secured upon a sidewall of the arc slot 8, aligned to place the annular gear 12 within the arc slot 8 for engagement with the pinion gear 14, enabling for example, fabrication of the annular gear 12 of metal material and a remainder of the alignment mechanism of lighter and/or cheaper polymer material.

One skilled in the art will appreciate that the alignment mechanism 2 may enable antenna mounts 2 which may be configured with a reduced size and streamlined overall appearance. Further, precision alignment adjustments may be quickly applied with reduced strain upon the installation personnel, without specialized tools.

Table of Parts

| | |
|---|---|
| 2 | alignment mechanism |
| 4 | first body |
| 6 | circular arc surface |
| 8 | arc slot |
| 10 | center point |
| 11 | inner sidewall |
| 12 | annular gear |
| 14 | pinion gear |
| 16 | second body |
| 18 | spindle |
| 20 | tool interface |
| 22 | washer |
| 24 | antenna mount |
| 26 | antenna |
| 28 | pole |
| 30 | motor |
| 32 | flange end |
| 34 | rotation fastener |

Where in the foregoing description reference has been made to materials, ratios, integers or components having known equivalents then such equivalents are herein incorporated as if individually set forth.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details, representative apparatus, methods, and illustrative examples shown and described. Accordingly, departures may be made from such details without departure from the spirit or scope of applicant's general inventive concept. Further, it is to be appreciated that improvements and/or modifications may be made thereto without departing from the scope or spirit of the present invention as defined by the following claims.

We claim:

1. An alignment adjustment mechanism for an antenna; comprising:
a first body and a second body coupled to one another rotatable with respect to each other about a center point; one of the first body and the second body coupled to the antenna;
the first body provided with a circular arc surface; the arc surface centered upon the center point; the arc surface provided with an annular gear;
a pinion gear rotatably coupled to the second body;
the pinion gear engaging the annular gear, whereby rotation of the pinion gear rotates the first body about the center point.

2. The mechanism of claim 1, wherein the annular gear is provided on an inner sidewall of an arc slot of the first body.

3. The mechanism of claim 1, wherein the pinion gear is provided with a tool interface.

4. The mechanism of claim 1, wherein the pinion gear is driven by a motor.

5. The mechanism of claim 1, wherein the rotatable coupling between the first body and the second body is via a spindle passing through the center point.

6. The mechanism of claim 1, wherein the rotatable coupling between the first body and the second body is lockable via a spindle passing through a pivot circular arc slot of one of the first body and the second body; the pivot circular arc slot centered upon the center point.

7. The mechanism of claim 1, wherein the first body is coupled to the antenna and the second body is coupled to a mounting point of the antenna.

8. The mechanism of claim 1, wherein a rotation axis between the first body and the second body is coaxial with a boresight of the antenna.

9. The mechanism of claim 1, wherein a rotation axis between the first body and the second body is parallel to a horizontal plane of the antenna.

10. The mechanism of claim 1, wherein a rotation axis between the first body and the second body is parallel to a vertical plane of the antenna.

11. The mechanism of claim 1, wherein the pinion gear is rotatably coupled to the second body by a spindle.

12. The mechanism of claim 1, wherein the first body and the annular gear are a unitary portion of material.

13. A method for manufacturing an alignment adjustment mechanism for an antenna;
comprising steps of:
providing a first body provided with a circular arc surface; the arc surface centered upon a center point; the arc surface provided with an annular gear;
providing a second body;
rotatably coupling a pinion gear to the second body;
coupling the first body and the second body to one another rotatable with respect to each other about the center point, the pinion gear engaging the annular gear,
whereby rotation of the pinion gear rotates the first body about the center point.

14. The method of claim 13, wherein the annular gear is provided on an inner sidewall of a drive arc slot of the first body.

15. The method of claim 13, wherein the pinion gear is provided with a tool interface.

16. The method of claim 13, wherein the annular gear is formed via injection molding the first body.

17. The method of claim 13, wherein the annular gear is formed via metal stamping the first body.

18. The method of claim 13, wherein the annular gear is formed via casting the first body.

19. The method of claim 13, wherein the annular gear is provided with the first body as a unitary portion.

20. The method of claim 13, wherein the pinion gear is coupled to a motor; and the motor is coupled to the second body.
